(19) United States
(12) Patent Application Publication
(10) Pub. No.: US 2026/0171907 A1
(43) Pub. Date: Jun. 18, 2026

(54) METHOD, CONTROLLER, AND COMPUTER PROGRAM FOR OPERATING A THREE-PORT SERIES RESONANCE CONVERTER, CONVERTER ARRANGEMENT, AND COMPUTER-READABLE MEDIUM

(71) Applicant: ABB Schweiz AG, Baden (CH)

(72) Inventors: Julian BOEHLER, Zurich (CH); Sami Pettersson, Dietikon (CH); Francisco Canales, Baden-Dattwill (CH)

(21) Appl. No.: 19/416,020

(22) Filed: Dec. 11, 2025

(30) Foreign Application Priority Data
Dec. 12, 2024 (EP) 24219446.2

(51) Int. Cl. H02M 3/00; H02M 1/00; H02M 3/335

(52) U.S. Cl. CPC H02M 3/01; H02M 1/0058; H02M 3/33573; H02M 3/33576

(57) ABSTRACT

A method for operating a three-port series resonance converter is described. The three-port series resonance converter has a main feeding bridge, at least one auxiliary feeding bridge, and an output bridge. The method comprises sending one or more control signals to one or more switches of the feeding bridges based on a predetermined control scheme such that input voltages applied to the feeding bridges are transformed to an overall output voltage to be provided by the output bridge, and delaying a turn on signal for activating one of the feeding bridges such that transformer currents of the feeding bridges reach at least approximately zero at least approximately at the same time.

### CROSS REFERENCE TO RELATED APPLICATIONS

The present application claims priority to European Patent Application No. 24219446.2 filed on Dec. 12, 2024, and titled “METHOD, CONTROLLER, AND COMPUTER PROGRAM FOR OPERATING A THREE-PORT SERIES RESONANCE CONVERTER, CONVERTER ARRANGEMENT, AND COMPUTER-READABLE MEDIUM”, which is hereby incorporated by reference in its entirety.

### TECHNICAL FIELD

The present disclosure relates to the field of electrical converters and to the control of electrical converters. In particular, the present disclosure relates to a method, a controller and, a computer program for controlling a three-port series resonance converter, to a converter arrangement comprising the controller and the three-port series resonance converter, and to a computer-readable medium, on which the computer program is stored.

### BACKGROUND

In general, electrical converters are used for converting an input voltage to an output voltage, for example, from a Low Voltage (LV) to a Medium Voltage (MV) or vice versa. The LV region as used in this description may range from 120 V to 1500 V, and the MV region may refer to voltages larger than 1500 V. One known class of electrical converters is represented by resonance converters, such as for example, a two-port or three-port Series Resonance Converters (SRC).

A two-port SRC has an input bridge and an output bridge coupled to each other by a transformer. A three-port SRC has a main input bridge, an auxiliary input bridge, and an output bridge, wherein each of the input bridges is coupled to the output bridge by a transformer. The two-port as well as the three-port SRC can be operated in two directions, such that in a first operating mode the input voltage is provided to the input bridges and the output voltage is provided by the output bridge and in a second operating mode the input voltage is provided to the output bridge and the output voltage is provided by the input bridges.

One of the advantages of a two-port SRC is that it offers an operating mode called “Half-Cycle Discontinuous Conduction Mode (HC-DCM)”, for which the two-port SRC inherently guarantees soft-switching over the entire operating range while also allowing a very simple open-loop control implementation. In this operating mode, only a feeding bridge of the two-port SRC is actively switched while an output bridge of the two-port SRC is operated as a passive diode rectifier.

The straightforward approach to operate the three-port SRC converter with two feeding bridges would be to also apply the same modulation scheme typically used for the conventional two-port SRC, in other words, actively switching both feeding bridges on the LV side with fixed frequency and full duty cycle based on the corresponding control scheme while the output side bridge on the MV side is operating as a passive diode rectifier. In particular, for a power flow from the MV to the two LV side feeding bridges this can be trivially achieved by applying the same modulation strategy as in case of the two-port SRC. However, in case of a power flow from the two LV feeding bridges to the MV output bridge, the modulation approach used in conventional two-port SRCs leads to circulating currents between two power flow paths, resulting in a loss of soft-switching and reduced power flow controllability, except for some exceptional loading scenarios.

As long as resonance frequencies of the feeding bridges are at least approximately the same, a method for controlling a three-port SRC as described in the not yet published patent application EP 24 217 330.0 may be used. However, the resonance frequencies of the feeding bridges may vary, for example, due to tolerances of the involved components, and/or may deviate from each other. This deviation in resonance frequencies may again lead to circulating currents between the two feeding bridges, resulting in a loss of zero-current switching of at least one of the bridges

### BRIEF DESCRIPTION

It is an objective of the present disclosure to provide a method, a controller, and a computer program for controlling a three-port SRC, which enable to use the HC-DCM operation for the three-port SRC, in particular if the power flows from the LV feeding bridges towards the MV output bridge, and/or to enable to maintain zero-current switching for the active bridges, in some embodiments, over the entire operating range, and to control a ratio of the power flows between the feeding bridges, in particular when the resonance frequencies of the feeding bridges are not the same. It is another object of the present disclosure, to provide a converter arrangement having the controller and the three-port SRC, and a computer-readable medium on which the computer program is stored.

These objectives are achieved by the subject-matter of the independent claims. Further exemplary embodiments are evident from the dependent claims and the following description. The embodiments and features, if any, described in this specification that do not fall under the scope of the independent claim are to be interpreted as examples useful for understanding various embodiments of the present disclosure.

An aspect of the present disclosure relates to a method for operating a three-port series resonance converter. The three-port series resonance converter has a main feeding bridge, at least one auxiliary feeding bridge, and an output bridge. The main feeding bridge is electro-magnetically coupled to the output bridge via a first input coil of the main feeding bridge, and the auxiliary feeding bridge is electro-magnetically coupled to the output bridge via a second input coil of the auxiliary feeding bridge. The method comprises: sending one or more control signals to one or more switches of the feeding bridges based on a predetermined control scheme such that input voltages applied to the feeding bridges are transformed to an overall output voltage to be provided by the output bridge; and delaying a turn on signal for activating one of the feeding bridges such that transformer currents of the feeding bridges reach at least approximately zero at least approximately at the same time.

Another aspect of the present disclosure relates to a controller for operating the three-port series resonance converter. The controller has a memory for storing one or more voltage values and/or current values; and a processor being communicatively coupled to the memory and being configured to carry out the method as introduced above and described in the following based on the stored voltage values and/or, respectively, current values.

Another aspect of the present disclosure relates to the converter arrangement. The converter arrangement has the three-port SRC, and the controller being communicatively coupled to the three-port SRC and being configured for operating the three-port SRC.

Another aspect of the present disclosure relates to a computer program for operating the three-port SRC, wherein the computer program has computer-readable instructions which, when being executed by the processor of the controller carry out the method as introduced above and described in the following.

Another aspect of the present disclosure relates to a computer-readable medium on which the computer program is stored. The computer-readable medium may be a floppy disk, a hard disk, an USB (Universal Serial Bus) storage device, a RAM (Random Access Memory), a ROM (Read Only Memory), an EPROM (Erasable Programmable Read Only Memory) or a FLASH memory. The computer readable medium may also be a data communication network, for example, the Internet, which allows downloading a program code. In general, the computer-readable medium may be a non-transitory or transitory medium.

It has to be understood that some features of the present disclosure are described with respect to one of the aspects only for conciseness reasons and to avoid unnecessary repetitions, but that these features may be easily transferred to one or more of the other aspects by the person skilled in the art.

The method for operating the three-port SRC represents a new control strategy for the three-port SRC operated with at least two feeding input ports, in other words, the main feeding bridge and the auxiliary feeding bridge. This new method enables to establish a Half-Cycle Discontinuous Conduction Mode (HC-DCM) operation of the three-port SRC similar to a two-port SRC. The proposed method uses a freewheeling state of the feeding bridges to suppress circulating currents between the two feeding ports, which would form between the two feeding bridges if the port power differs from a specific ratio defined by circuit resonance elements of the three-port SRC. To establish an at least approximately simultaneous zero crossing of transformer currents of both feeding bridges the turn-on of one of the feeding bridges is delayed. In other words, by applying different turn-on times for the feeding bridges because of the delay, both transformer currents can be synchronized to reach their zero-crossing at the same time. With the proposed solution, soft-switching operation of the three-port SRC can be guaranteed while maintaining a simple power flow controllability similar to an operating behavior of a conventional single- or two-port series resonance converter.

That the transformer currents of the feeding bridges reach at least approximately zero at least approximately at the same time may mean in this context that the transformer currents of the feeding bridges reach at least approximately zero at least approximately at the same time at an end of an active interval of the feeding bridges. In this context, the active interval may be initiated and/or started by sending the one or more control signals.

That the transformer currents reach “at least approximately zero” may mean that the transformer currents are zero or that a deviation of the transformer currents from zero is smaller than 20%, for example, smaller than 5%, for example, smaller than 0.1%, of a maximal transformer current of the feeding bridges.

That the transformer currents reach at least approximately zero “at least approximately at the same time” may mean in this context that the transformer currents reach zero at the same time or that a duration between the first one of the transformer currents reaching at least approximately zero and the second one of the transformer currents reaching at least approximately zero is smaller than 20%, for example, smaller than 5%, for example, smaller than 0.1%, of a duration of the active interval of one of the feeding bridges.

The main feeding bridge and/or the auxiliary feeding bridge each may be full-bridges having four switches, or half-bridges having two switches. In some embodiments, the three-port SRC may have two or more auxiliary feeding bridges. The output bridge may be used for an active rectification of the output bridge current.

The electro-magnetic coupling of the main feeding bridge to the output bridge via the first input coil and the electro-magnetic coupling of the auxiliary feeding bridge to the output bridge via the second input coil may be realized by the three-port SRC having one single transformer. This single transformer may have one single output coil being electrically coupled with the output bridge and being inductively coupled with the first input coil and with the second input coil. Alternatively, the three-port SRC may have one transformer for each of the feeding bridges. In this case, a first output coil of a first transformer of the three-port series resonance converter may be electrically coupled with the output bridge and electro-magnetically coupled with the first input coil, and a second output coil of a second transformer of the three-port series resonance converter may be electrically coupled with the output bridge and electro-magnetically coupled with the second input coil of the auxiliary feeding bridge.

According to an embodiment of the present disclosure, the method comprises: determining a delay time which is needed for delaying the turn on signal such that transformer currents of the feeding bridges are at least approximately zero at least approximately at the same time, wherein the turn on signal is delayed for the determined delay time. Determining the delay time and delaying the turn on signal accordingly may contribute to that the transformer currents are very precisely zero and/or very precisely at the same time.

According to an embodiment of the present disclosure, the method comprises determining the resonance frequencies f_{res,m}, f_{res,a} of the feeding bridges and determining the delay time from the determined resonance frequencies f_{res,m}, f_{res,a}. (claim 3) This may contribute to easily and precisely determining the delay time.

According to an embodiment of the present disclosure, the delay time is determined by

$$Δ t = \vert \frac{1}{2 {f}_{res , m}} - \frac{1}{2 {f}_{res , a}} \vert$$

According to an embodiment of the present disclosure, the turn on signal of the feeding bridge which has the higher resonance frequency f_{res,m}, f_{res,a} is delayed for the delay time. So, the feeding bridge which is connected to the resonance tank featuring the higher resonance frequency and therefore faster reaching its zero-crossing is delayed.

These and other aspects of the present disclosure will be apparent from and elucidated with reference to the embodiments described hereinafter.

### BRIEF DESCRIPTION OF DRAWINGS

The subject matter of the present disclosure will be explained in more detail in the following text with reference to exemplary embodiments which are illustrated in the attached drawings.

FIG. 1 shows an electric circuit diagram of an exemplary embodiment of a three-port SRC of the present disclosure.

FIG. 2 shows an equivalent circuit diagram of the three-port SRC of FIG. 1.

FIG. 3 shows examples of transformer currents of feeding bridges of the three-port SRC according to FIGS. 1 and 2, without delaying a turn on signal for turning on the corresponding feeding bridge.

FIG. 4 shows examples of voltage and current measurements measured at the three-port SRC of FIG. 1, without delaying the turn on signal for the corresponding feeding bridge.

FIG. 5 shows examples of transformer currents of feeding bridges of the three-port SRC according to FIGS. 1 and 2, with delaying the turn on signal for turning on the corresponding feeding bridge.

FIG. 6 shows examples of voltage and current measurements measured at the three-port SRC of FIG. 1, with delaying the turn on signal for the corresponding feeding bridge.

FIG. 7 shows a flow diagram of an exemplary embodiment of a method for controlling the three-port SRC of FIG. 1.

The reference symbols used in the drawings, and their meanings, are listed in summary form in the list of reference symbols. In principle, identical parts are provided with the same reference symbols in the figures.

### DETAILED DESCRIPTION

Reference will now be made in detail to the various embodiments, one or more examples of which are illustrated in each figure. Each example is provided by way of explanation and is not meant as a limitation. For example, features illustrated or described as part of one embodiment can be used on or in conjunction with any other embodiment to yield yet a further embodiment. It is intended that the present disclosure includes such modifications and variations.

Within the following description of the drawings, the same reference numbers refer to the same or to similar components. In some instances, the same or similar components may be assigned a different reference number, for example, due to a different configuration within the electronic circuit. Generally, only the differences with respect to the individual embodiments are described. Unless specified otherwise, the description of a part or aspect in one embodiment applies to a corresponding part or aspect in another embodiment as well.

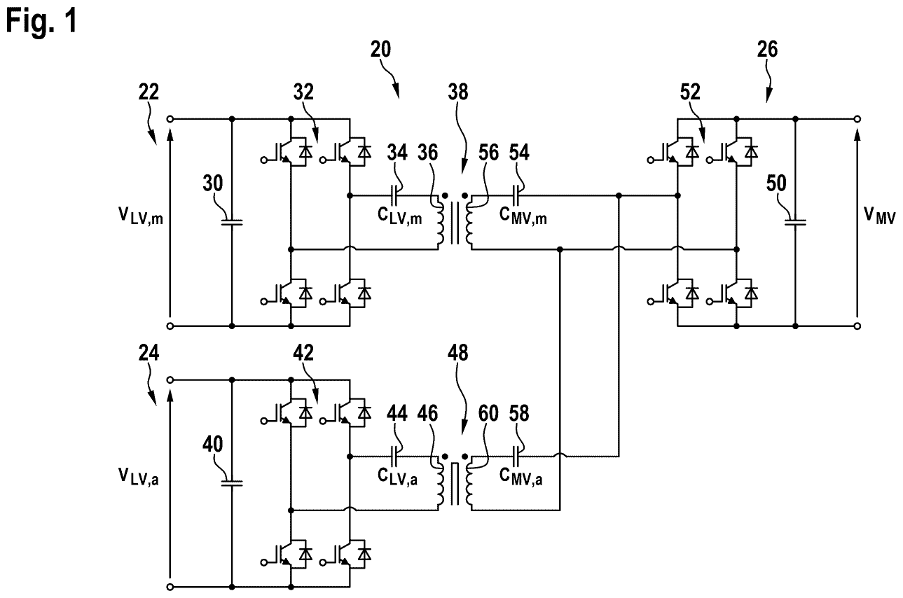

FIG. 1 shows an electric circuit diagram of an exemplary embodiment of a three-port Series Resonance Converter (SRC) 20. The three-port SRC 20 has a main feeding bridge 22, at least one auxiliary feeding bridge 24, and an output bridge 26. In some embodiments, the three-port SRC 20 may have more than one auxiliary feeding bridge 24.

The main feeding bridge 22 has a first DC link 30, at least two, for example, four, first switches 32, a first capacitor input 34 and a first input coil 36. The first switches 32 each may be a semiconductor switch. Each first switch 32 may comprise a dedicated first diode which may act as a freewheeling diode. The first input capacitor 34 has a first input capacitance C_{LV,m}.

The auxiliary feeding bridge 24 has a second DC link 40, at least two, for example, four, second switches 42, a second input capacitor 44 and a second input coil 46. The second switches 42 each may be a semiconductor switch. Each second switch 32 may comprise a dedicated second diode which may act as a freewheeling diode. The second input capacitor 44 has a second input capacitance C_{LV,a}.

The output bridge 26 has an output DC link 50, at least two, for example, four, output switches 52, a first output capacitor 54, a second output capacitor 58, a first output inductance 56, and a second output inductance 60. The output switches 52 each may be a semiconductor switch. Each output switch 52 may comprise a dedicated output diode which may act as a freewheeling diode. The first output capacitor 54 has a first output capacitance C_{MV,m}. The second output capacitor 58 has a second output capacitance C_{MV,a}.

So, the main feeding bridge 22 and the auxiliary feeding bridge 24 each may be full-bridges having four switches 32, 42. Alternatively, the main feeding bridge 22 and the auxiliary feeding bridge 24 each may be half-bridges (not shown) having two switches 32, 42 only.

The main feeding bridge 22 is electro-magnetically coupled to the output bridge 26 via the first input coil 36 of the main feeding bridge 22 and the first output inductance 56 of the output bridge 26. The first output inductance 56 may be provided by a first output coil. The first input coil 36 and the first output coil may form a first transformer 38 of the three-port SRC 20 or may be components of the first transformer 38. The auxiliary feeding bridge 24 is electro-magnetically coupled to the output bridge 26 via the second input coil 46 of the auxiliary feeding bridge 24 and the second output inductance 60 of the output bridge 26. The second output inductance 60 may be provided by a second output coil. The second input coil 46 and the second output coil may form a second transformer 48 of the three-port SRC 20 or may be components of the second transformer 48. Alternatively, the three-port SRC 20 may have only one transformer (not shown) with only one output inductance, for example, one single output coil, wherein both of the input coils 36, 46 may be electro-magnetically coupled to the single output coil.

The three-port SRC 20 is configured for receiving a first input voltage V_{LV,m} via the main feeding bridge 22, for receiving a second input voltage V_{LV,a} via the auxiliary feeding bridge 24, and for generating an overall output voltage V_{MV} at an output of the output bridge 26 from the input voltages V_{LV,m}, V_{LV,a}. In this context, the output bridge 26 may be used for an active rectification of an output bridge current provided by the output bridge 26.

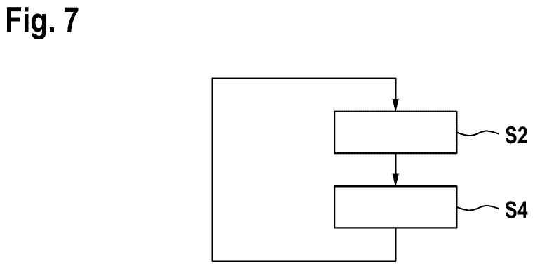

To this end, the three-port SRC 20 may be controlled by a controller (not shown) based on a predetermined control scheme. The controller has a memory (not shown) for storing one or more voltage values and/or current values, and a processor (not shown) being communicatively coupled to the memory and being configured to carry out the method as introduced in the foregoing and explained in detail with respect to FIG. 7 based on the stored voltage values and/or, respectively, current values. The controller may be communicatively coupled to the switches 32, 42, 52 of the bridges 22, 24, 26 and may be configured for providing one or more control signals to individually or collectively activate the switches 32, 42, 52 and for providing one or more turn off signal to individually or collectively deactivate, in other words turn off, the switches 32, 42, 52.

Basically, the three-port SRC 20 may be operated vice versa such that an overall input voltage may be provided to the output bridge 20 and that the three-port SRC 20 converts the overall input voltage into individual output voltages provided by the main feeding bridge 22 and, respectively, the auxiliary feeding bridge 24. However, in this case, a conventional method for operating a two-port SRC (not shown) may be used for this alternative power flow direction. Therefore, the present description focusses on the power flow from the feeding bridges 22, 24 to the output bridge 26.

The three-port SRC 20 and the controller being communicatively coupled to the three-port SRC 20 may form a converter arrangement or may be part of a converter arrangement.

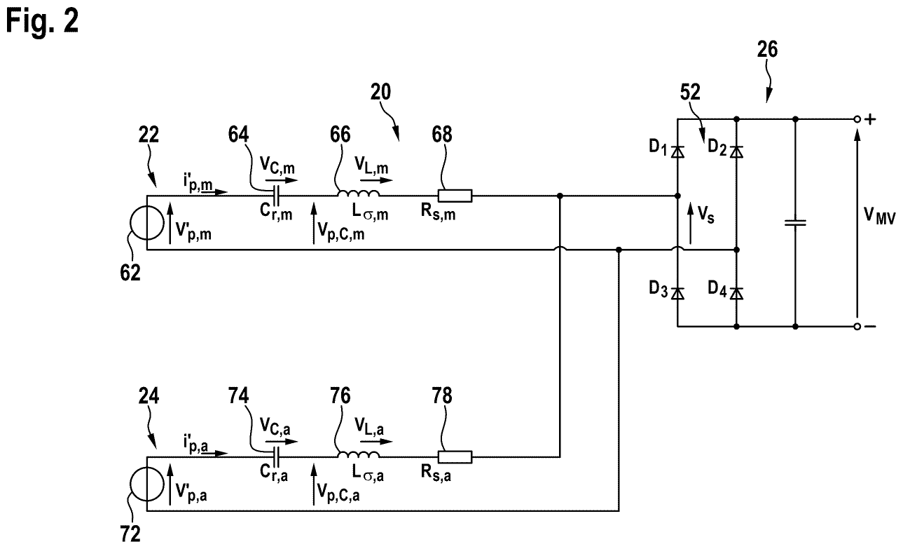

FIG. 2 shows an equivalent circuit diagram of the three-port SRC of FIG. 1. The first DC link 30 and the first switches 32 of the main feeding bridge 22 are represented by a first ideal voltage source 62. The second DC link 40 and the second switches 42 of the auxiliary feeding bridge 24 are represented by a second ideal voltage source 72.

The first input capacitor 34 and the first output capacitor 54 may be represented by a first substitute capacitor 64. As such, the first input capacitance C_{LV,m} and the first output capacitance C_{MV,m} may be summarized into a first resonance capacitance C_{r,m}. The second input capacitor 44 and the second output capacitor 58 may be represented by a second substitute capacitor 74. As such, the second input capacitance C_{LV,a} and the second output capacitance C_{MV,a} may be summarized into a second resonance capacitance C_{r,a}.

The first transformer 38 may be represented by a first substitute inductance 66 and may be modelled by a first leakage inductance L_{σ,m}. The second transformer 48 may be represented by a second substitute inductance 76 and may be modelled by a second leakage inductance L_{σ,a}.

A first substitute resistor 68 may represent conduction losses of the first switches 32, the first diodes, the first transformer 38, and the output switches 52 and may be neglected in the following. A second substitute resistor 78 may represent conduction losses of the second switches 42, the second diodes, the second transformer 58, and the output switches 52 and may be neglected in the following.

The output switches 52 are represented by their output diodes which are referred to by D1, D2, D3, and D4, in FIG. 2.

A first resonance frequency f_{res,m} of the main feeding bridge 22 may be given by

$${f}_{res , m} = \frac{1}{\sqrt{{L}_{σ , m} {C}_{r , m}}} .$$

A second resonance frequency f_{res,a} of the auxiliary feeding bridge 24 may be given by

$${f}_{res , a} = \frac{1}{\sqrt{{L}_{σ , a} {C}_{r , a}}} .$$

The leakage inductances L_{σ,m}, L_{σ,a} and the resonance capacitances C_{r,m}, C_{r,a} are chosen such that the first resonance frequency om and the second resonance frequency ωₐ are not the same, for example, by design and/or due to component tolerances.

The first ideal voltage source 62 may provide a first output voltage v′_{p,m}. The first output voltage v′_{p,m} may cause a first transformer current i′_{p,m} which may lead to a first capacitor voltage v_{C,m} over the first substitute capacitor 64, to a first primary capacitor voltage v_{p,C,m} between the two parallel lines of the main feeding bridge 22, and to a first inductor voltage v_{L,m} over the first substitute inductance 66. It has to be mentioned in this context, that all quantities characterized by the apostrophe “′” are quantities scaled by the turn ratios of their respective transformers of the three-port SRC 20. In particular, in this description, the LV side quantities are scaled up to the MV quantities to enhance the calculability, as it is known in the art.

Similarly, the second ideal voltage source 72 may provide a second output voltage v′_{p,a}. The second output voltage v′_{p,a} may cause a second transformer current i′_{p,a} which may lead to a second capacitor voltage v_{C,a} over the second substitute capacitor 74, to a second primary capacitor voltage v_{p,C,a} between the two parallel lines of the auxiliary feeding bridge 24, and to a second inductor voltage v_{L,a} over the second substitute inductance 76.

These voltages cause a resulting voltage vs in the output bridge 26. The transformer currents i′_{p,m}, i′_{p,a} may be summed up to get the output bridge current of the three-port SRC 20. In other words, the output bridge current of the three-port SRC 20 may correspond to the sum of the transformer currents i′_{p,m}, i′_{p,a}.

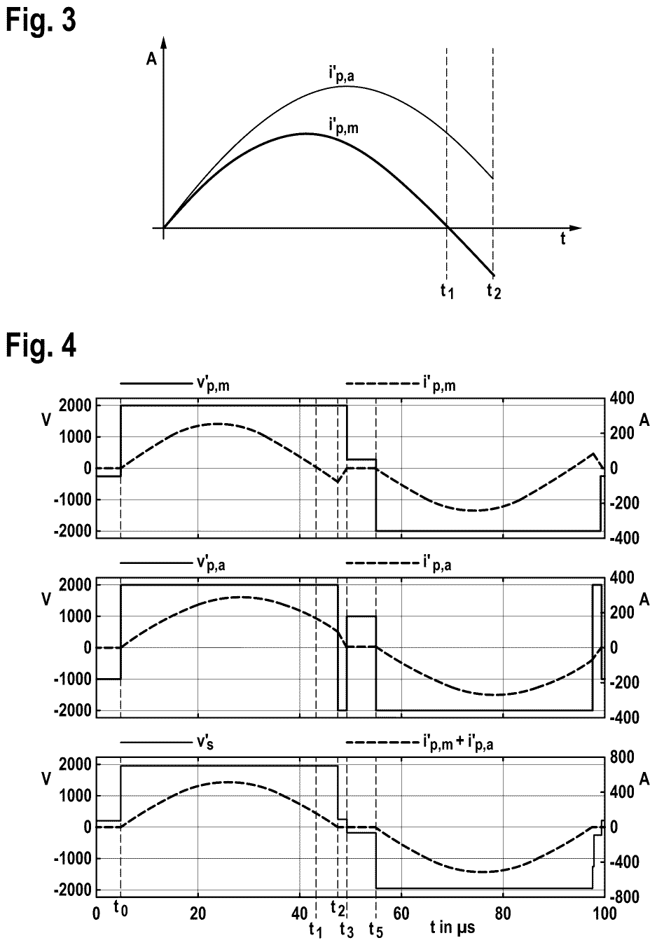

FIG. 3 shows examples of the transformer currents i′_{p,m}, i′_{p,a} of the feeding bridges 22, 24 of the three-port SRC 20 according to FIGS. 1 and 2, without delaying a turn on signal for turning on the corresponding feeding bridge 22, 24. So, the values shown in the diagrams of FIG. 3 where captured while the three-port SRC 20 was operated in accordance with the predetermined control scheme and without using the method for operating the three-port series resonance converter 20 as disclosed herein and as described with respect to FIG. 7.

Because the resonance frequencies are not the same as mentioned above, but deviate from each other, there is no unique zero crossing of the transformer currents i′_{p,m}, i′_{p,a} anymore. In contrast, the transformer current i′_{p,m}, i′_{p,a} of the feeding bridge 22, 24 featuring the higher resonance frequency reaches the zero crossing faster than the other. For example, in FIG. 3, the first transformer current i′_{p,m} reaches zero first since it is assumed that the first resonance frequency f_{res,m} is larger than the second resonance frequency f_{res,a}. In particular, at the end of the active interval shown in FIG. 3, the first transformer current i′_{p,m} is at least approximately zero at a first point in time t₁ and the second transformer current i′_{p,a} is at least approximately zero at a second point in time t₂ wherein the first point in time t₁ is before the second point in time t₂. At the second point in time t₂, a magnitude of the first transformer current i′_{p,m} may be the same as a magnitude of the second transformer current i′_{p,a}, wherein the signs of the transformer currents i′_{p,m}, i′_{p,a} are different with respect to each other.

As a consequence, the first transformer current i′_{p,m} will start to reverse while the second transformer current i′_{p,a} is still delivering power to the output bridge 26, therefore keeping the output bridge 26 forward biased, as explained with respect to FIG. 4.

FIG. 4 shows examples of voltage and current measurements measured at the three-port SRC 20 of FIG. 1. The diagrams in the first line show the first output voltage v′_{p,m} and the first transformer current i′_{p,m} in the main feeding bridge 22. The diagrams in the second line show the second output voltage v′_{p,a} and the second transformer current i′_{p,a} in the auxiliary feeding bridge 24. The diagrams in the third line show the resulting voltage vs, and an output bridge current of the output bridge 26 corresponding to the sum of the transformer currents i′_{p,m}, i′_{p,a} in the output bridge 26.

As may be seen from the diagrams in the first two lines, the transformer currents i′_{p,m}, i′_{p,a} firstly rise up from zero at a starting time instance to with rising edges of the corresponding output voltage v′_{p,m}, v′_{p,a}, wherein the edges of the output voltage v′_{p,m}, v′_{p,a} mark switching operations according to a predetermined control scheme. Then, the transformer currents i′_{p,m}, i′_{p,a} go down towards zero, wherein this phase, during which the transformer currents i′_{p,m}, i′_{p,a} are above zero, represents a first active interval of the three-port SRC 20.

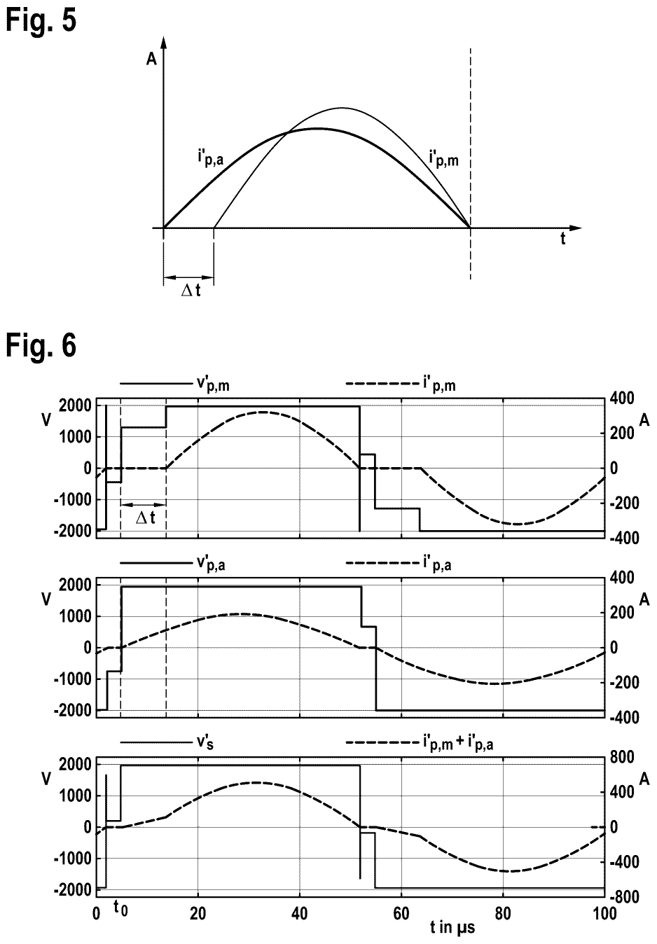

At the end of the first active interval, the transformer currents i′_{p,m}, i′_{p,a} do not reach zero at the same time because of the deviating resonance frequencies of the feeding bridges 22, 24. In particular, the first transformer current i′_{p,m} is already zero at a first time instance t₁ while the second transformer currents i′_{p,a} is still larger than zero. In this situation, the first transformer current i′_{p,m} will start to reverse, in particular at the first time instance t₁. The reversing first transformer current i′_{p,m} then rises until its value equals the second transformer currents i′_{p,a} but with opposite sign. At a second time instance t₂, the output bridge 26 starts to block. This reversal of the first transformer current i′_{p,m} may be avoided by the method for operating the three-port SRC 20, as explained with respect to FIGS. 5 to 7.

The next phase, during which the transformer currents i′_{p,m}, i′_{p,a} decrease to zero and during which the output bridge 26 blocks, represents a pre-holdoff interval of the three-port SRC 20 that ends at a third time instance t₃. This third time instance t₃ marks a beginning of the holdoff time. The time interval between the second and third time instances t₂, t₃ may be referred to as “pre-holdoff time” in the following. In order to eliminate a coupling between the two feeding bridges 22, 24 during the holdoff interval it may be ensured that the inductor voltages v_{L,m}, v_{L,a} stay zero during the holdoff interval, as described in the above mentioned not yet published patent application EP 24 217 330.0. In particular, since the resulting voltage vs of the output bridge 26 cannot float independently for the two feeding bridges 22, 24, this may be accomplished by enabling at least one of the AC outputs of the actively switched feeding bridges 22, 24 on the LV side to float during the holdoff time which ends at a fifth time instance t₅. For example, this may be achieved by turning off all four switches of one (or both) of the feeding bridges 22, 24 once the three-port SRC 20 enters the pre-holdoff interval. Once the transformer currents i′_{p,m}, i′_{p,a} reached approximately zero, they stay approximately zero due to the absence of a close current path in this situation until a new switching cycle is initiated with a new switching action of one or both of the active bridges.

However, it is advantageous in this case to guarantee that both transformer currents i′_{p,m}, i′_{p,a}, are zero or at least approximately zero at the same time. This may be achieved by delaying a turn on signal for turning on the faster one of the feeding bridges 22, 24, in other words by delaying an entry into the active phase, as explained with respect to FIGS. 5 and 6.

After the holdoff interval a second active interval starts during which the transformer currents i′_{p,m}, i′_{p,a} are below zero, wherein the same problem arises at the end of the second active interval as for the first active interval, as described above.

FIG. 5 shows examples of the transformer currents i′_{p,m}, i′_{p,a} of feeding bridges 22, 24 of the three-port SRC 20 according to FIGS. 1 and 2, with delaying the turn on signal for turning on the faster feeding bridge 22, 24, which is the main feeding bridge 22 in the present example, for a delay time Δt. As may be seen from FIG. 5, both transformer currents i′_{p,m}, i′_{p,a} are zero or at least approximately zero at the end of the first active interval, and the holdoff interval, in particular the transformer currents i′_{p,m}, i′_{p,a} being zero or at least approximately zero during the holdoff interval, can be guaranteed.

FIG. 6 shows examples of voltage and current measurements measured at the three-port SRC 20 of FIG. 1, with delaying the turn on signal for the (faster) main feeding bridge 22, 24, in particular for the delay time Δt. As may be seen from FIG. 6, both transformer currents i′_{p,m}, i′_{p,a} reach zero or at least approximately zero at the same time. Now, the holdoff interval can be guaranteed, for example, by turning off at least one of the feeding bridges 22, 24.

After the holdoff interval, the second active phase is entered, wherein the turn on signal for the faster feeding bridge, in other words, the main feeding bridge 22 in the present example, and thereby the first transformer current i′_{p,m} is delayed again to guarantee the next holdoff interval.

FIG. 7 shows a flow diagram of an exemplary embodiment of a method for controlling the three-port SRC 20 of FIG. 1.

In an activity S2, the delay time Δt may be determined. The delay time Δt may be determined by

$$Δ t = \vert \frac{1}{2 {f}_{res , m}} - \frac{1}{2 {f}_{res , a}} \vert .$$

In an activity S4, one or more control signals may be sent to one or more switches 32, 42 of the feeding bridges 22, 24 based on a predetermined control scheme such that the input voltages V_{LV,m}, V_{LV,a} applied to the feeding bridges 22, 24 are transformed to the output bridge voltage to be provided by the output bridge 26, wherein the turn on signals for the faster feeding bridge, for example, the main feeding bridge 22, are delayed for the determined delay time Δt at the beginning of the active intervals. This activity may be carried out continuously while operating the three-port SRC 20. The predetermined control scheme may be based on Pulse Width Modulation (PWM) or on Model Predictive Control (MPC), for example.

In some embodiments, the turn off signal may be sent to at least some of the switches 32, 42 of at least one of the feeding bridges 22, 24 during the holdoff intervals such that the output voltage v′_{p,m}, v′_{p,a} of the corresponding feeding bridge 22, 24 is floating to guarantee the transformer currents i′_{p,m}, i′_{p,a} being zero or at least approximately zero during the holdoff intervals.

The method for controlling the three-port SRC 20 may be embodied as a computer program for operating the three-port SRC 20. The computer program has computer-readable instructions which, when being executed by the processor of the controller for controlling the three-port SRC 20 carry out the method for controlling the three-port SRC 20 as described in the foregoing. The computer program may be stored on a computer-readable medium. The computer-readable medium may be a floppy disk, a hard disk, an USB (Universal Serial Bus) storage device, a RAM (Random Access Memory), a ROM (Read Only Memory), an EPROM (Erasable Programmable Read Only Memory) or a FLASH memory. The computer readable medium may also be a data communication network, for example, the Internet, which allows downloading a program code. In general, the computer-readable medium may be a non-transitory or transitory medium.

While the present disclosure has been illustrated and described in detail in the drawings and foregoing description, such illustration and description are to be considered illustrative or exemplary and not restrictive; the present disclosure is not limited to the disclosed embodiments. Other variations to the disclosed embodiments can be understood and effected by those skilled in the art and practising the present disclosure, from a study of the drawings, the disclosure, and the appended claims. In the claims, the word “comprising” does not exclude other elements or activities, and the indefinite article “a” or “an” does not exclude a plurality. A single processor or controller or other unit may fulfil the functions of several items recited in the claims. The mere fact that certain measures are recited in mutually different dependent claims does not indicate that a combination of these measures cannot be used to advantage. Any reference signs in the claims should not be construed as limiting the scope.

The disclosed systems and methods are not limited to the specific embodiments described herein. Rather, components of the systems or activities of the methods may be utilized independently and separately from other described components or activities.

This written description uses examples to disclose various embodiments, which include the best mode, to enable any person skilled in the art to practice those embodiments, including making and using any devices or systems and performing any incorporated methods. The patentable scope is defined by the claims and may include other examples that occur to those skilled in the art. Such other examples are intended to be within the scope of the claims if they have structural elements that do not differ from the literal language of the claims, or if they include equivalent structural elements with insubstantial differences form the literal language of the claims.

1. A method for operating a three-port series resonance converter, the three-port series resonance converter having a main feeding bridge, at least one auxiliary feeding bridge, and an output bridge, wherein the main feeding bridge is electro-magnetically coupled to the output bridge via a first input coil of the main feeding bridge, and the auxiliary feeding bridge is electro-magnetically coupled to the output bridge via a second input coil of the auxiliary feeding bridge, the method comprising:
sending one or more control signals to one or more switches of the feeding bridges based on a predetermined control scheme such that input voltages applied to the feeding bridges are transformed to an overall output voltage to be provided by the output bridge; and
delaying a turn on signal for activating one of the feeding bridges such that transformer currents of the feeding bridges reach at least approximately zero at least approximately at the same time.

2. The method according to claim 1, further comprising:
determining a delay time which is needed for delaying the turn on signal such that transformer currents of the feeding bridges are at least approximately zero at least approximately at the same time, wherein the turn on signal is delayed for the determined delay time.

3. The method according to claim 2, further comprising:
determining resonance frequencies of the feeding bridges, wherein the delay time is determined from the determined resonance frequencies.

4. The method according to claim 3, wherein the delay time is determined by:
$$Δ t = \vert 1 / ( 2 f\_ ( res , m ) ) - 1 / 2 f\_ ( res , a ) ) \vert .$$

5. The method according to claim 3, wherein:
the turn on signal of the feeding bridge which has a higher resonance frequency is delayed for the delay time.

6. A controller for operating a three-port series resonance converter, the three-port series resonance converter having a main feeding bridge, at least one auxiliary feeding bridge, and an output bridge, wherein the main feeding bridge is electro-magnetically coupled to the output bridge via a first input coil of the main feeding bridge, and the auxiliary feeding bridge is electro-magnetically coupled to the output bridge via a second input coil of the auxiliary feeding bridge, the controller comprising:
a memory for storing one or more voltage values and/or current values; and
at least one processor communicatively coupled to the memory and configured, based on the stored voltage values and/or, respectively, current values to:
send one or more control signals to one or more switches of the feeding bridges based on a predetermined control scheme such that input voltages applied to the feeding bridges are transformed to an overall output voltage to be provided by the output bridge; and
delay a turn on signal for activating one of the feeding bridges such that transformer currents of the feeding bridges reach at least approximately zero at least approximately at the same time.

7. A converter arrangement, comprising:
a three-port series resonance converter, the three-port series resonance converter having a main feeding bridge, at least one auxiliary feeding bridge, and an output bridge, wherein the main feeding bridge is electro-magnetically coupled to the output bridge via a first input coil of the main feeding bridge, and the auxiliary feeding bridge is electro-magnetically coupled to the output bridge via a second input coil of the auxiliary feeding bridge; and
a controller communicatively coupled to the three-port series resonance converter and configured to;
send one or more control signals to one or more switches of the feeding bridges based on a predetermined control scheme such that input voltages applied to the feeding bridges are transformed to an overall output voltage to be provided by the output bridge; and
delay a turn on signal for activating one of the feeding bridges such that transformer currents of the feeding bridges reach at least approximately zero at least approximately at the same time.

8-9. (canceled)

10. The method according to claim 4, wherein:
the turn on signal of the feeding bridge which has a higher resonance frequency is delayed for the delay time.

11. The controller according to claim 6, wherein the at least one processor is further configured to:
determine a delay time which is needed for delaying the turn on signal such that transformer currents of the feeding bridges are at least approximately zero at least approximately at the same time, wherein the turn on signal is delayed for the determined delay time.

12. The controller according to claim 11, wherein the at least one processor is further configured to:
determine resonance frequencies of the feeding bridges, wherein the delay time is determined from the determined resonance frequencies.

13. The controller according to claim 12, wherein the at least one processor is further configured to:
delay the turn on signal of the feeding bridge which has a higher resonance frequency for the delay time.

14. The controller according to claim 12, wherein the at least one processor is further configured to determine the delay time by:
$$Δ t = \vert 1 / ( 2 f\_ ( res , m ) ) - 1 / ( 2 f\_ ( res , a ) ) \vert .$$

15. The controller according to claim 14, wherein the at least one processor is further configured to:
delay the turn on signal of the feeding bridge which has a higher resonance frequency for the delay time.

16. The converter arrangement according to claim 7, wherein the controller is further configured to:
determine a delay time which is needed for delaying the turn on signal such that transformer currents of the feeding bridges are at least approximately zero at least approximately at the same time, wherein the turn on signal is delayed for the determined delay time.

17. The converter arrangement according to claim 16, wherein the controller is further configured to:
determine resonance frequencies of the feeding bridges, wherein the delay time is determined from the determined resonance frequencies.

18. The converter arrangement according to claim 17, wherein the controller is further configured to:
delay the turn on signal of the feeding bridge which has a higher resonance frequency for the delay time.

19. The converter arrangement according to claim 17, wherein the controller is further configured to determine the delay time by:
$$Δ t = \vert 1 / ( 2 f\_ ( res , m ) ) - 1 / ( 2 f\_ ( res , a ) ) \vert .$$

20. The converter arrangement according to claim 19, wherein the controller is further configured to:
delay the turn on signal of the feeding bridge which has a higher resonance frequency for the delay time.
